(19) United States
(12) Patent Application Publication
(10) Pub. No.: US 2024/0294436 A1
(43) Pub. Date: Sep. 5, 2024

(54) CERAMIC STRUCTURE AND METHOD FOR MANUFACTURING SAME

(71) Applicant: CANON KABUSHIKI KAISHA, Tokyo (JP)

(72) Inventors: Shunsuke Murakami, Tokyo (JP); KANAKO OSHIMA, Tokyo (JP); YASUSHI SHIMIZU, Kanagawa (JP); NOBUHIRO YASUI, Kanagawa (JP); CHIAKI ARII, Tokyo (JP); TOMOHIRO UNNO, Shizuoka (JP); KOJI NISHIKAWA, Chiba (JP)

(21) Appl. No.: 18/658,681

(22) Filed: May 8, 2024

Related U.S. Application Data
(63) Continuation of application No. PCT/JP2022/042001, filed on Nov. 10, 2022.

(30) Foreign Application Priority Data
Nov. 12, 2021 (JP) 2021-184895
Nov. 9, 2022 (JP) 2022-179505

(51) Int. Cl. C04B 35/185; B33Y 10/00; B33Y 40/20; B33Y 70/00; C04B 35/119; C04B 35/64

(52) U.S. Cl. CPC C04B 35/185; B33Y 10/00; B33Y 40/20; B33Y 70/00; C04B 35/119; C04B 35/64; C04B 2235/5436; C04B 2235/6026

(57) ABSTRACT

A ceramic structure includes at least a region comprising mullite, a region comprising oxide which contains Si and Al richer in Si than the mullite, and a region comprising aluminum oxide, wherein an oxide-equivalent mole ratio SiO₂/Al₂O₃ satisfies 0.1/0.9 to 0.7/0.3.

### CROSS-REFERENCE TO RELATED APPLICATIONS

This application is a Continuation of International Patent Application No. PCT/JP2022/042001, filed Nov. 10, 2022, which claims the benefit of Japanese Patent Applications No. 2021-184895, filed Nov. 12, 2021, and No. 2022-179505, filed Nov. 9, 2022, all of which are hereby incorporated by reference herein in their entirety.

### BACKGROUND OF THE INVENTION

### Field of the Invention

The present invention relates to a ceramic structure obtained by direct shaping and a method for manufacturing the same.

### Background Art

Additive manufacturing techniques for obtaining a desired structure by adding material based on shape data on a three-dimensional model to be manufactured are becoming widespread as a means of manufacturing prototypes and small quantities of objects. In the manufacturing of metal objects, direct shaping using a laser beam to irradiate metal powder and solidify the powder for shaping is widely employed. This method can produce various objects by effectively melting and solidifying metal powders.

In recent years, approaches have been made to develop additive manufacturing techniques using ceramic powders. Unlike metals, common ceramics such as aluminum oxide and zirconium oxide have low absorbability for laser beam wavelengths, and therefore significantly higher energy needs to be applied to melt the ceramic powders. However, even with the application of high energy, diffusion of the laser beam makes the melting nonuniform and it has been difficult to achieve a desired fabrication precision.

Patent Literature 1 discusses a technique for adding an absorber having high absorbability for the wavelength of the irradiating laser beam to the material powder to reduce beam diffusion and achieve high fabrication precision. Patent literature 2 discusses a technique for manufacturing a ceramic structure by direct shaping using powder comprising mainly silicon dioxide as a material, to which an absorber having high absorbability for the wavelength of the irradiating laser beam is added.

### CITATION LIST

### Patent Literature

PTL 1: Japanese Patent Laid-Open No. 2019-19051
PTL 2: Japanese Patent Laid-Open No. 2021-66177

Patent Literature 1 discusses Al₂O₃—ZrO₂ powders and Al₂O₃—SiO₂ powders to which Tb₄O₇ is added as an absorber. Patent Literature 2 discusses Al₂O₃—SiO₂ powders to which SiO is added as an absorber. Since SiO₂ is inexpensive and easily available, Al₂O₃—SiO₂ powders are particularly desirable in terms of stable low-cost manufacturing of ceramic structures.

However, shaped objects fabricated from material powder with an SiO₂ ratio exceeding 70 mol % using direct shaping methods like those of Patent Literature 1 and Patent Literature 2 are porous and tend to lack mechanical strength for use as structural parts such as machine parts or medical parts.

### SUMMARY OF THE INVENTION

A ceramic structure according to the present invention includes at least a region comprising mullite, a region comprising oxide which contains Si and Al richer in Si than the mullite, and a region comprising aluminum oxide, wherein an oxide-equivalent mole ratio SiO₂/Al₂O₃ satisfies 0.1/0.9 to 0.7/0.3.

A method for manufacturing a ceramic structure according to the present invention includes the steps of: (i) disposing powder containing silicon dioxide particles, aluminum oxide particles, and an absorber exhibiting higher light absorption for a wavelength of light included in an irradiating laser beam than that of silica and alumina, an oxide-equivalent mole ratio SiO₂/Al₂O₃ of the powder satisfying 0.1/0.9 to 0.7/0.3, (ii) irradiating the powder with the laser beam to melt the powder, followed by solidification, and (iii) subjecting a shaped object obtained by performing steps (i) and (ii) a plurality of times to heat treatment so that a maximum temperature reached is 1595° C. or higher and lower than 1730° C.

Further features of the present invention will become apparent from the following description of exemplary embodiments with reference to the attached drawings.

### BRIEF DESCRIPTION OF THE DRAWINGS

FIG. 1A is a schematic sectional view schematically illustrating an exemplary embodiment of a method for manufacturing a shaped object by powder bed fusion.

FIG. 1B is a schematic sectional view schematically illustrating the exemplary embodiment of the method for manufacturing a shaped object by powder bed fusion.

FIG. 1C is a schematic sectional view schematically illustrating the exemplary embodiment of the method for manufacturing a shaped object by powder bed fusion.

FIG. 1D is a schematic sectional view schematically illustrating the exemplary embodiment of the method for manufacturing a shaped object by powder bed fusion.

FIG. 1E is a schematic sectional view schematically illustrating the exemplary embodiment of the method for manufacturing a shaped object by powder bed fusion.

FIG. 1F is a schematic sectional view schematically illustrating the exemplary embodiment of the method for manufacturing a shaped object by powder bed fusion.

FIG. 1G is a schematic sectional view schematically illustrating the exemplary embodiment of the method for manufacturing a shaped object by powder bed fusion.

FIG. 1H is a schematic sectional view schematically illustrating the exemplary embodiment of the method for manufacturing a shaped object by powder bed fusion.

FIG. 2A is a schematic sectional view schematically illustrating an exemplary embodiment of a method for manufacturing a shaped object by cladding.

FIG. 2B is a schematic sectional view schematically illustrating the exemplary embodiment of the method for manufacturing a shaped object by cladding.

FIG. 2C is a schematic sectional view schematically illustrating the exemplary embodiment of the method for manufacturing a shaped object by cladding.

FIG. 3A is a scanning electron microscope (SEM) image of a section of a typical ceramic structure according to the present invention.

FIG. 3B is an Al elemental mapping image of the section illustrated in FIG. 3A.

FIG. 3C is an Si elemental mapping image of the section illustrated in FIG. 3A.

FIG. 4A is a SEM image of a section of a ceramic structure according to a twentieth example.

FIG. 4B is an Al elemental mapping image of the section illustrated in FIG. 4A.

FIG. 4C is an Si elemental mapping image of the section illustrated in FIG. 4A.

FIG. 5A is a SEM image of a section of a ceramic structure according to a nineteenth example.

FIG. 5B is an Al elemental mapping image of the section illustrated in FIG. 5A.

FIG. 5C is an Si elemental mapping image of the section illustrated in FIG. 5A.

### DESCRIPTION OF THE EMBODIMENTS

Exemplary embodiments of the present invention will be described below in conjunction with specific examples and with reference to the drawings. However, the present invention is not limited in any way to the following specific examples or drawings.

Among direct shaping methods, powder bed fusion and directional energy deposition (so-called cladding) are suitably used for the present invention.

In this description, silicon dioxide may be referred to as silica or SiO₂. Aluminum oxide may be referred to as alumina or Al₂O₃. Silicon dioxide has a plurality of different crystalline forms, but will be referred to simply as silicon dioxide or silica, or using the chemical formula SiO₂ if states such as amorphous, crystalline, and other crystal structures do not matter.

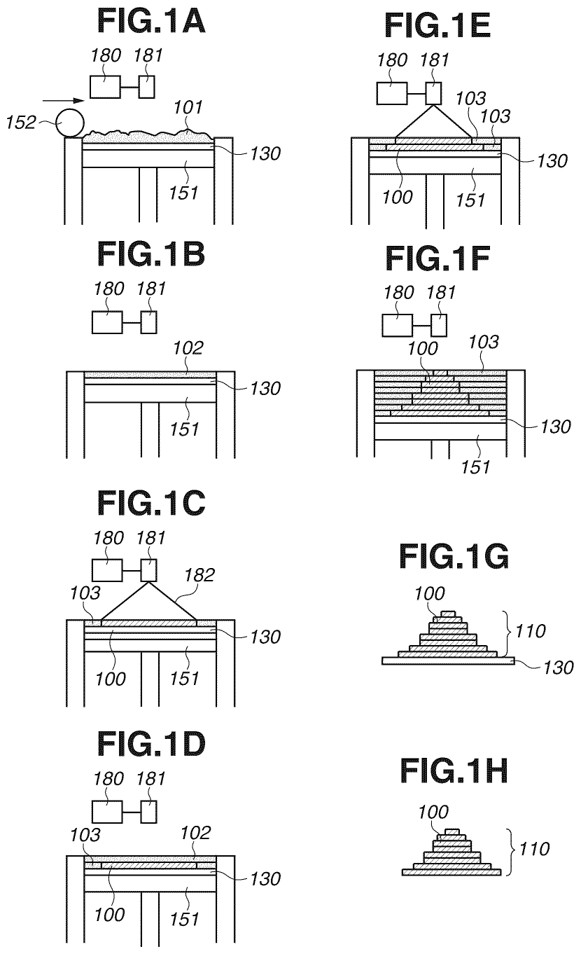

FIGS. 1A to 1H are schematic sectional views schematically illustrating a basic fabrication procedure of a manufacturing method using powder bed fusion.

Initially, material powder 101 is placed on a base 130 installed on a stage 151, and leveled to a predetermined thickness by a roller 152 to form a powder layer 102 (FIGS. 1A and 1B). The powder layer 102 is irradiated with a laser beam that is emitted from a laser light source 180 and scanned by a scanner unit 181 based on slice data generated from shape data on a desired three-dimensional model. In an irradiation range 182 of the laser beam, the material powder melts and then solidifies to form a solidified portion 100 corresponding to a layer of slice data (FIG. 1C). The stage 151 is then lowered and a new powder layer 102 is formed over the solidified portion 100 (FIG. 1D), and the new powder layer 102 is irradiated with the laser beam based on the slice data. Such a series of processes is repeated a number of times corresponding to the slice data, whereby a shaped object 110 is obtained (FIGS. 1E and 1F). Finally, unsolidified material powder 103 is removed, and unwanted portions of the shaped object are removed and the shaped object and the base are separated as needed (FIGS. 1G and 1H).

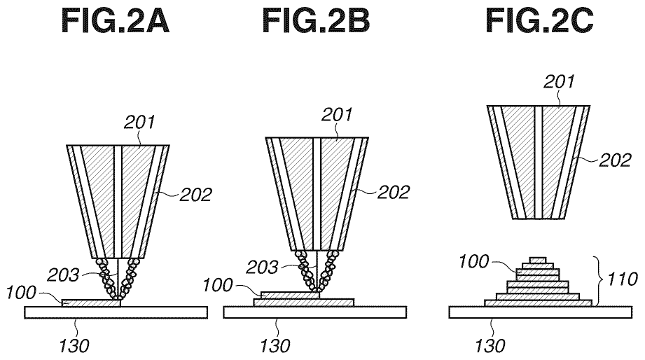

FIGS. 2A to 2C are schematic sectional views schematically illustrating a basic fabrication procedure of a manufacturing method using cladding. Material powder is discharged from a plurality of powder supply holes 202 in a cladding nozzle 201 and the area where the powder is focused is irradiated with a laser beam 203 while additively forming a solidified portion 100 based on slice data (FIG. 2A). This process is continuously performed to obtain a shaped object 110 (FIGS. 2B and 2C). Finally, unwanted portions of the shaped object are removed and the shaped object and the base are separated as needed.

In the case of direct shaping methods such as powder bed fusion and cladding, the particles included in the material powder melt during the laser beam irradiation. When the laser beam irradiation is finished, the particles are rapidly cooled from around to form the solidified portion 100. Silica powder, when molten, has high viscosity and does not spread out, and thus solidifies into a granular form when cooled. Our study found that ceramic structures formed only of silica powder have a high porosity and do not provide sufficient mechanical strength.

The present invention therefore uses mixed powder of silica powder and alumina powder, containing absorber particles, silicon dioxide particles, and aluminum oxide particles so that an oxide-equivalent mole ratio SiO₂/Al₂O₃ satisfies 0.1/0.9 to 0.7/0.3. For oxide equivalent conversion, silicon oxides including SiO are calculated as SiO₂ regardless of the composition, and aluminum oxides as Al₂O₃ regardless of the composition.

Silica has a thermal conductivity of approximately 1.5 W/m·K. Alumina has a thermal conductivity of approximately 30 W/m·K, which is approximately 20 times as high as that of silica. Alumina particles with the high thermal conductivity are thus preferentially melted by the laser beam irradiation. If a predetermined ratio of alumina is added to silica, the preferentially melted alumina melt contacts the silica particles or silica melt with high viscosity, and the melts are mixed into a molten state of low viscosity. Since the melt viscosity is reduced in such a manner, a shaped object of low porosity (high compactness) and high mechanical strength can be obtained compared to the case where silica-rich material powder is used.

During the laser beam irradiation, part of the molten silica reacts with the molten alumna to form mullite, a silica-alumina compound. However, in the case of fabrication methods where the material powder is melted and solidified by short-pulse laser beam irradiation like powder bed fusion and cladding, the alumina and silica particles may fail to be fully melted. Some of the particles may be left unreacted and simply remain in the solidified portion as long as an amount needed for fabrication is melted.

Since the portions irradiated with the laser beam melt and solidify in a short time, the resulting shaped object often cracks due to thermal stress. Cracks are distributed throughout the entire shaped object (structure), i.e., at the surface and inside. Most cracks are around 5 nm to 50 μm in width and can cause a drop in the mechanical strength of the shaped object.

A ceramic structure according to the present invention is obtained by applying heat treatment at a temperature of 1595° C. or higher and lower than 1730° C. to the shaped object fabricated by the procedure of FIGS. 1A to 1H or FIGS. 2A to 2C, and can provide high mechanical strength. The reason for the improvement of the mechanical strength by the heat treatment at a temperature of 1595° C. or higher and lower than 1730° C. is presumed as follows:

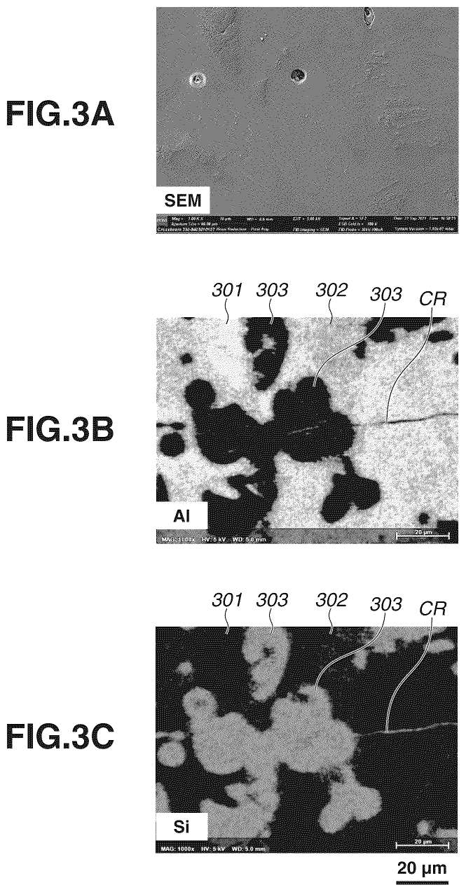

FIG. 3A is an example of a secondary electron image (scanning electron microscope [SEM] image) of a section of the ceramic structure subjected to the heat treatment at 1595° C. or higher and lower than 1730° C., observed under a SEM. FIGS. 3B and 3C are elemental mapping images (energy dispersive X-ray spectroscopy [EDS]) illustrating the distribution of Al and Si, respectively.

A region 301 comprising aluminum oxide appears the brightest in FIG. 3B and the darkest in FIG. 3C. A region 302 comprising mullite appears the second brightest in FIG. 3B and the second darkest in FIG. 3C. The composition of the region is expressed as Al₆Si₂O₁₃. Regions 303 comprising oxide which contains Si and Al appear dark in FIG. 3B and bright in FIG. 3C. The regions 303 have a composition close to a eutectic composition of silica and mullite. The regions having the composition close to the eutectic composition of silica and mullite have an element number ratio Si/Al of 6 to 12 and are richer in Si than the region comprising mullite, with an oxide-equivalent mole ratio SiO₂/Al₂O₃ of 12 to 24.

The heat treatment in the foregoing temperature range softens or melts the regions (regions comprising oxide which contains Si and Al) 303 having the composition close to the eutectic composition (eutectic point: 1595° C.) of silica and mullite, with the melting point within the temperature range. The molten components spread out from the regions 303 by capillary action through cracks caused by the thermal stress, whereby the cracks are repaired with the oxide which contains Si and Al. The present invention is not affected even when compositions mixed with other regions are formed on part of the wall surfaces facing the cracks. In FIG. 3C, a streak-like region CR leading to a region 303 comprising oxide which contains Si and Al is observed in the middle. This streak-like region corresponds to the position of a crack caused by thermal stress during fabrication, and is thus considered to be a crack repaired by the molten components constituting the region 303 intruding into and spreading through the crack during the foregoing heat treatment. With cracks thus repaired, the ceramic structure after the heat treatment has less cracks and improves in mechanical strength. For such a reason, the streak-like region CR is included in the region 303 comprising oxide which contains Si and Al.

Considering the density of cracks occurring during fabrication, at least one region CR, or repaired crack, can be observed in a 2 mm×2 mm two-dimensional area. A region CR has an average width of 1 μm or more and a length-to-average-width ratio of 10 or more, and can thus be distinguished from regions not derived from cracks. Here, the average width is an average of the widths of the region CR measured at five or more locations. If the region CR extends not straight but in a curved shape, the length measured along the curve is used.

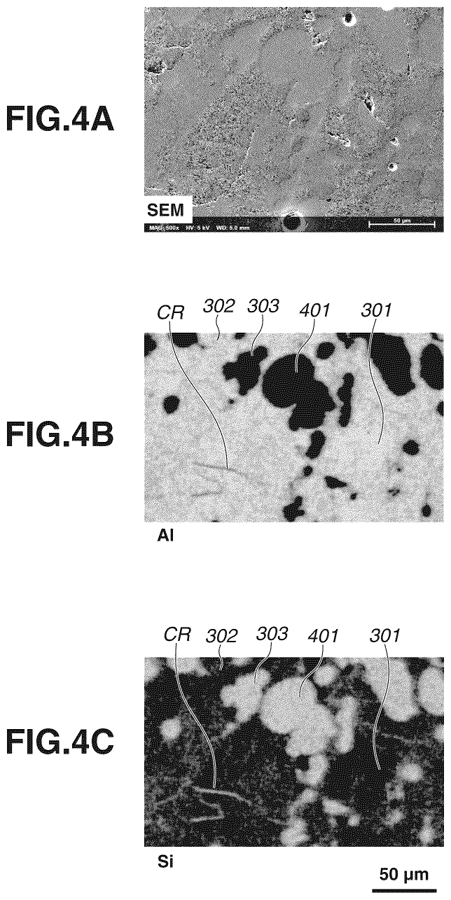

FIG. 4A is an example of a SEM image of a section of the ceramic structure subjected to the heat treatment at 1595° C. or higher and lower than 1730° under different conditions from in FIG. 3A. FIGS. 4B and 4C are elemental mapping images of FIG. 4A, illustrating the distribution of Al and Si, respectively.

Like FIGS. 3A to 3C, a region 301 comprising aluminum oxide appears the brightest in FIG. 4B and the darkest in FIG. 4C. A region 302 comprising mullite appears the second brightest in FIG. 4B and the second darkest in FIG. 4C. A region 303 comprising oxide which contains Si and Al appears the second darkest in FIG. 4B and second brightest in FIG. 4B. A region 401 comprising silicon dioxide appears the darkest in FIG. 4B and the brightest in FIG. 4C. In such a manner, the shaped object after the heat treatment may include the region 401 comprising silicon dioxide as illustrated in FIGS. 4A to 4C in addition to at least three regions including a region comprising oxide which contains Si and Al, a region comprising mullite, and a region comprising aluminum oxide.

As described above, the region 301 comprising aluminum oxide and the region 401 comprising silicon dioxide are considered to be regions where some of silica particles and alumina particles left unmelted during fabrication remain intact even after the heat treatment. The shorter the duration of the heat treatment, the more regions comprising silicon dioxide the composite ceramic structure tends to include.

Ceramic structures including three or four regions improve significantly in mechanical strength compared to before the heat treatment. This is considered to be due to the following phenomenon, in addition to the cracks being repaired: For a ceramic structure with three regions, the region comprising silicon dioxide is considered to transform into a region comprising oxide which contains Si and Al or a region comprising mullite in an extended duration of the heat treatment. In the process of this transformation, the porosity can be reduced to improve the mechanical strength. For a ceramic structure with four regions, the region comprising silicon dioxide transforms into a state of containing cristobalite as a preliminary stage to the transformation into a region comprising oxide which contains Si and Al or a region comprising mullite. In the region comprising silicon dioxide included in the shaped object before the heat treatment, most of portions once melted by laser beam irradiation and then solidified have an amorphous structure. Cristobalite has higher density and higher mechanical strength than those of the amorphous structure, and the mechanical strength of the ceramic structure is considered to thus improve as a result of the transformation of the region comprising silicon dioxide into the state of containing cristobalite.

To transform the region 401 comprising silicon dioxide into the state of containing cristobalite, the heat treatment conditions and the particle diameter and crystalline state of the silicon dioxide particles used in the material powder can be adjusted. By adjusting the particle diameter and crystalline state of the silicon dioxide particles, the size and crystalline state of the region comprising silicon dioxide before heating can be adjusted. The state of the region comprising silicon dioxide before heating also affects the state of the region 401 comprising silicon dioxide after the heat treatment. Whether the region 401 comprising silicon dioxide is included in the ceramic structure, and if included, the final size and crystalline state of the region 401 comprising silicon dioxide can be controlled by adjusting the heat treatment conditions.

To further improve the mechanical strength of the shaped object, the cracks in the shaped object can be impregnated with a repair solution containing metal components before the heat treatment. Ordinary sintering turns cracks into regions 303 comprising oxide which contains Si and Al. By contrast, if the cracks are impregnated with the repair solution before the heat treatment, the melt of regions comprising oxide which contains Si and Al and the solid components of the repair solution react to generate oxides containing the metal components included in the repair solution, whereby the cracks are repaired to form regions CR. If regions comprising oxide containing the metal components included in the repair solution are formed in the regions CR, the composition of the shaped object becomes more complex and the mechanical strength of the shaped object improves. In such a case, the metal components derived from the repair solution provided for regions 302 are dispersed into not only the regions CR but also regions 303 comprising oxide which contains Si and Al in connection with the regions CR during the heat treatment.

The material powder used in the present invention and a method for manufacturing a ceramic structure will now be described in more detail.

### [Material Powder]

The material powder contains an absorber, silicon dioxide particles, and aluminum oxide particles. The oxide-equivalent mole ratio SiO₂/Al₂O₃ satisfies 0.1/0.9 to 0.7/0.3. Here, SiO is regarded as SiO₂ for oxide equivalent conversion.

The silica particles and alumina particles constituting the material powder desirably have near-spherical shapes for sufficient fluidity so that the material powder is compactly leveled out to a predetermined thickness on the base 130. To reduce powder aggregation and manufacture a shaped object with high precision, both the silica particles and the alumina particles desirably have an average particle diameter of 5 μm or more and 200 μm or less, preferably 10 μm or more and 150 μm or less. The average particle diameter of powder according to the present invention refers to a median diameter (median). The average particle diameter of powder is calculated as an equivalent circle diameter of the projected images from micrographs of the powder.

The bonding state of Si and O in the silica particles constituting the powder is not limited in particular, and can be amorphous, crystalline like cristobalite and quartz, or a mixed state of these.

The absorber refers to a component (element or compound) having a high light absorbability for the wavelength of light included in the irradiating laser beam during fabrication compared to silica and alumina. The absorbability, or absorption ratio, of the absorber for the wavelength of the used laser beam is desirably higher than or equal to 10%, preferably higher than or equal to 40%, yet preferably higher than or equal to 60%. The absorption ratio of the absorber can be measured using a common spectrometer. Specifically, a sample dish filled with the absorber is installed in an integrating sphere as a sample, and irradiated at an intended wavelength (near the laser wavelength used in manufacturing) to measure the value of the electromagnetic spectrum. The absorption ratio is calculated from the ratio of the value to a measurement without a sample.

Such an absorber efficiently absorbs the laser beam used during manufacturing and increases its own temperature, whereby heat is conducted to other compositions in the area corresponding to the focus size of the laser beam leading to temperature increase. This achieves effective local heating, and the interface between a processed area (area irradiated with the laser beam) and an unprocessed area (area not irradiated with the laser beam) can be clarified for improved fabrication precision.

The absorber desirably transforms, at least in part, into another composition with low light absorbability due to the laser beam irradiation. Examples include a composition that transforms into another metal oxide with relatively low light absorbability for the laser beam due to the valences of the metal elements changing as a result of oxygen desorption by a temperature increase. A decrease in the light absorbability to or below 5/6 times before the laser beam irradiation prevents an adverse effect on the fabrication precision even when the solidified portion is irradiated with the laser beam. In other words, there is little absorber in the solidified portion after the laser beam irradiation, and a temperature increase like before the laser beam irradiation will not occur. The solidified portion is thereby prevented from deformation or transformation if powder adjoining the solidified portion is irradiated with the laser beam. This increases process margins for the irradiation conditions of the laser light, and can reduce the impact of fluctuations in the irradiation conditions on the fabrication precision. For higher fabrication precision, the light absorbability after the laser beam irradiation desirably drops to or below ½ before the laser beam irradiation.

For the absorber, a composition that transforms into another composition and gets incorporated into the shaped object through combination with another composition included in the atmospheric gas or the powder or by causing a decomposition reaction such as oxygen desorption under the laser beam irradiation may be used.

Compositions suitable for the absorber include SiO, Tb₄O₇, Pr₆O₁₁, Ti₂O₃, TiO, ZnO, antimony-doped tin oxide (ATO), indium-doped tin oxide (ITO), MnO, MnO₂, Mn₂O₃, Mn₃O₄, FeO, Fe₂O₃, Fe₃O₄, Cu₂O, CuO, Cr₂O₃, CrO₃, NiO, V₂O₃, VO₂, V₂O₅, V₂O₄, Co₃O₄, CoO, transition metal carbides, transition metal nitrides, Si₃N₄, AlN, borides, and silicides. Suitable transition metal carbides include TiC and ZrC. Suitable transition metal nitrides include TiN and ZrN. Suitable borides include TiB₂, ZrB₂, and LaB₆. Suitable silicides include TiSi₂, ZrSi₂, and MoSi₂. At least one selected from the group including these can be used as the absorber.

A composition having high affinity with other compositions constituting the powder is desirably selected and used as the absorber. Since the material powder according to the present invention contains silica and aluminum, metal oxides with high affinity are desirable for the absorber. SiO with high affinity for silica is particularly desirable.

SiO is brown or black in color, and has high light absorbability for the wavelength of the irradiating laser beam during fabrication compared to aluminum and silica included in the material powder. When SiO absorbs the laser light, Si changes from divalent to tetravalent and metastable SiO transforms into stable SiO₂. SiO is also desirable because its light absorbability for the laser light drops. The transformation of SiO into SiO₂, the main component of the material powder, after the laser beam irradiation is desirable for the purpose of fabrication where no additional component is wanted. Moreover, SiO is commercially available as negative electrodes for lithium ion secondary batteries and therefore advantageous also because of the availability at low price compared to other compounds usable as the absorber.

The absorber exhibiting favorable energy absorption for the laser beam is desirably finely and uniformly dispersed with the powder. This uniformizes reaction of the powder upon laser beam irradiation and further improves the fabrication precision. In view of this, the absorber particles (absorber powder) included in the powder desirably have an average particle diameter of 1 μm or more and less than 10 μm, preferably 1 μm or more and less than 5 μm.

The amount of absorber added is desirably 0.5 vol % or more and 10 vol % or less of the material powder. If the material powder contains 0.5 vol % or more of absorber, at least one or more absorber particles can statistically be present in the area irradiated with the laser beam under typical laser beam use conditions, and the effect of the addition of the absorber can be obtained. Incorporating 10 vol % or less of absorber can prevent a sharp temperature increase in the powder during laser beam irradiation, whereby the sputtering of the molten material around, i.e., a drop in the fabrication precision can be avoided.

To adjust the properties of the ceramic structure, compositions other than silica, alumina, or the absorber may be added to the material powder up to a proportion of less than 10 mass %.

While this description expresses compositions using chemical formulas such as SiO and Tb₄O₇, the actual elemental composition ratios do not need to strictly match the stoichiometric ratios as long as the intended purpose of the invention is fulfilled. In other words, the valences of metal elements constituting a composition may be somewhat different from those expected from the chemical formula. Errors of up to ±30% in the constituent element ratios from the stoichiometric ratios specified for the metal elements are acceptable. For example, if the absorber is SiO, an absorber having a constituent element ratio of Si:O=1:1.30 is included in the SiO. If SiO is used as the absorber, a more desirable elemental composition ratio in terms of providing a sufficient light absorbability deviates within +20% from the stoichiometric ratio.

### [Method for Manufacturing Ceramic Structure]

Next, a method for manufacturing the ceramic structure according to the present invention will be described in detail with reference to FIGS. 1A to 1H. The ceramic structure is obtained through the following three steps:
(i) disposing the material powder to a predetermined thickness on the fabrication surface;
(ii) irradiating the powder with laser beam to melt the powder, followed by solidification; and
(iii) heating the shaped object obtained by repeating steps (i) and (ii) at 1595° C. or higher and lower than 1730° C.
   <Step (i)>

As illustrated in FIGS. 1A to 1H, the material powder is disposed to the predetermined thickness on the fabrication surface (base 130) using a recoater (mechanism for laying powder) such as a roller and a blade. The material of the base 130 can be selected for use as appropriate from ceramics, metals, and glass, in consideration of the intended use purpose and the manufacturing conditions of the shaped object.

<Step (ii)>

The material powder disposed to the predetermined thickness in step (i) is irradiated with a laser beam that is scanned based on slice data generated from the shape data on the three-dimensional model to be manufactured. During the laser beam irradiation, the absorber included in the material powder absorbs the light energy, converts the light energy into heat, and melts itself and conveys the heat around, whereby the other powders in the laser-irradiated area are melted.

After the laser beam passes and the irradiation is finished, the heat of the molten area dissipates into the atmosphere and surroundings, whereby the molten area is cooled to form a solidified area. Since the temperature changes in the melting and solidification process are sharp, most of the regions comprising silicon dioxide and the regions comprising the oxide which contains Si and Al in the shaped object become an amorphous structure. The sharp temperature changes also cause stress at the surface and inside of the shaped object, whereby cracks are formed.

The type of laser beam is not limited in particular. General-purpose lasers such as a 1-μm-waveband yttrium aluminum garnet (YAG) laser or fiber laser and a 10-μm-waveband CO₂ laser are suitably used. If SiO is used as the absorber, a YAG laser or fiber laser emitting 1-μm-waveband light for which SiO exhibits high absorption is particularly desirable.

<Step (iii)>

In step (iii), the shaped object fabricated by repeating steps (i) and (ii) a predetermined number of times is subjected to the heat treatment so that the maximum temperature reached is 1595° C. or higher and lower than 1730° C. The number of repetitions of steps (i) and (ii) corresponds to the number of slices of the slice data.

The heating temperature range of step (iii), 1595° C. or higher and lower than 1730° C., is the temperature range where the oxide which contains Si and Al melts. The oxide which contains Si and Al thus melts in step (iii) and spreads through cracks due to the capillary action.

Such heat treatment can produce a shaped object that is stable at high temperature and has excellent mechanical strength. The shaped object after the heat treatment of step (iii) is a ceramic structure including at least three regions that are a region comprising oxide which contains Si and Al, a region comprising mullite, and a region comprising aluminum oxide. Specifically, the shaped object is a composite ceramic structure including three regions that are a region comprising oxide which contains Si and Al, a region comprising mullite, and a region comprising aluminum oxide, or a ceramic structure including four regions that further include a region comprising silicon dioxide. The region comprising oxide which contains Si and Al is a region where the element number ratio Si/Al is 6 to 12. The region comprising silicon dioxide is often included in a ceramic structure with short heat treatment time.

Which of the foregoing three or fourth regions the ceramic structure includes the most is determined by the mixing ratio of silicon dioxide and aluminum oxide contained in the material powder and the heat treatment conditions. The region 302 comprising mullite has relatively high mechanical strength, and its proportion in the ceramic structure is therefore desirably high. Specifically, the proportion is desirably higher than or equal to 75 vol % of the maximum amount of mullite (referred to as a maximum amount of mullite formation) calculated from the mole ratio SiO₂/Al₂O₃ in the ceramic structure. The proportion is preferably higher than or equal to 80 vol %, yet preferably higher than or equal to 90 vol %. The actual amount of mullite formation is determined by the laser irradiation conditions in step (ii) and the heat treatment conditions in step (iii). A comparison of structures having the same composition shows that ceramic structures with the amount of mullite formation higher than or equal to 75 vol % of the maximum amount of mullite formation can provide high mechanical strength.

Table 1 lists examples of the maximum amount of mullite formation calculated from the ratio of Si and Al included in the ceramic structure according to the present invention. The maximum amounts of regions comprising oxide which contains Si and Al and those of regions comprising aluminum oxide calculated by the same technique are also listed. The assumptions for the calculation are as follows: silicon dioxide has a molecular weight of 60.08 and a density of 2.3 g/cm³, and aluminum oxide has a molecular weight of 101.977 and a density of 3.96 g/cm³. Regions comprising oxide which contains Si and Al are assumed to have an element number ratio Si/Al=10, and the molecular weight calculated using the foregoing values is 62.09 and the density is 2.38 g/cm³. Mullite has a molecular weight of 426.05 and a density of 3.0 g/cm³.

TABLE 1

| | Maximum amounts of formation of regions (volume ratios) | | |
|---|---|---|---|
| Mole ratio | Regions | | |
| SiO₂/Al₂O₃ | comprising | | |
| (oxide- | oxide which | Regions | Regions |
| equivalent | contains | comprising | comprising |
| value) | Si and Al | mullite | aluminum oxide |
| 0.7/0.3 | 0.52 | 0.48 | 0 |
| 0.6/0.4 | 0.34 | 0.66 | 0 |
| 0.5/0.5 | 0.17 | 0.83 | 0 |
| 0.45/0.55 | 0.09 | 0.91 | 0 |
| 0.4/0.6 | 0 | 1 | 0 |
| 0.2/0.8 | 0 | 0.53 | 0.48 |
| 0.14/0.86 | 0 | 0.37 | 0.63 |
| 0.1/0.9 | 0 | 0.27 | 0.73 |

Depending on the combination of the heat treatment conditions in step (iii) and the state of silicon dioxide used for the material powder, the regions comprising silicon dioxide where amorphous silica is dominant immediately after fabrication can be transformed into cristobalite by the heat treatment. Cristobalite has high density and excellent mechanical strength compared to silicon dioxide of amorphous structure. If the ceramic structure includes regions comprising silicon dioxides, conditions are therefore desirably optimized so that the regions comprising silicon dioxides come to contain cristobalite.

The maximum temperature reached in step (iii) is desirably 1600° C. or higher and lower than 1720° C., preferably 1650° C. or higher and less than 1700° C. To fabricate a ceramic structure including three regions that are a region comprising oxide which contains Si and Al, a region comprising mullite, and a region comprising aluminum oxide, the heat treatment time can be increased. As a guideline for the heat treatment time to form the three regions, if, for example, the shaped object has a mole ratio SiO₂/Al₂O₃ of 0.56/0.44 and is heated to 1690° C., the maximum temperature maintaining time is desirably maintained for 40 minutes or more and 120 minutes or less.

The holding time may be short since cracks can be reduced once the maximum temperature near the cracks reaches the foregoing temperature range in step (iii). Note that if the heating time in the foregoing temperature range is too long or the heat treatment is performed at high temperature beyond the foregoing temperature range, average particle diameters in the respective regions tend to be so large that the mechanical strength of the ceramic structure drops. The heating time is therefore desirably adjusted within several hours. To prevent a drop in the mechanical strength of the ceramic structure, the heat treatment time is desirably 1 minute or more and 4 hours or less, preferably 5 minutes or more and 120 minutes or less, yet preferably 10 minutes or more and 80 minutes or less.

The heating method is not limited in particular. The shaped object may be irradiated with an energy beam again for heating, or heated in an electric furnace. In the case of energy beam heating, the relationship between the amount of heat input by the energy beam and the temperature of the shaped object is desirably found out in advance using a thermocouple, so that the shaped object can be heated to the foregoing desirable temperature.

The heat treatment is typically performed with the shaped object placed on a setter. However, the shaped object can melt at the surface or near cracks during the heating, and solidify and adhere to the setter after the heat treatment. The setter used for the heat treatment is therefore desirably an inert one. Examples of materials applicable for forming the inert setter include platinum in an atmospheric environment and iridium in a low-oxygen atmosphere.

The cracks in the shaped object can be repaired by impregnating the shaped object with a repair solution (solution containing a metal component) before the heat treatment, and then heating the shaped object. The metal component is desirably one that generates, when subjected to the heat treatment, a metal oxide and a phase capable of forming a eutectic with a phase constituting the shaped object. In particular, a metal component the eutectic temperature of which with silicon dioxide is lower than the maximum temperature the shaped object reaches during the heat treatment of step (iii) is desirable. The maximum temperature for the shaped object reached during the heat treatment of step (iii) can thus be set to below the melting point of silicon dioxide and above the eutectic temperature of the metal oxide with silicon dioxide.

With cracks impregnated with such a repair solution before the heat treatment, the vicinity of the cracks infiltrated with the metal component melts at a temperature lower than the melting point of the other portions of the shaped object, and the metal component diffuses inside the shaped object. As the temperature drops after the heating, crystals having a composition including the metal component recrystallize inside the shaped object. As a result, only the vicinity of the cracks can be softened to reduce or eliminate the cracks with the shape of the shaped object maintained. Here, the phase of the metal component-containing oxide precipitates to make the phase composition of the shaped object more complex, which can improve the mechanical strength of the shaped object.

The effect of reducing cracks in the shaped object is not obtained by adding the metal component used to repair cracks to the material powder in advance. If the material powder is rich in the metal component used to repair cracks, the melting point is unable to be locally lowered in the vicinity of the cracks, and the entire shaped object can be melted and deformed by the heat treatment. The material powder therefore desirably contains none of the metal elements included in the repair solution, or contains less than 3.0 mass % if any. The material powder preferably contains less than 2.0 mass % of metal elements.

As described above, to reduce cracks using the repair solution, it is important to apply the heat treatment with the shaped object impregnated with the repair solution to locally increase the density of the metal elements in the cracks. Such a technique can reduce cracks with high fabrication precision and improve the mechanical strength of the shaped object.

If a sufficient amount of metal component can be infiltrated throughout the shaped object, the technique for impregnating the shaped object with the repair solution is not limited in particular. The shaped object may be immersed in the repair solution for impregnation. The repair solution may be sprayed to the shaped object or applied to the surface with a brush, and allowed to be absorbed. A plurality of such techniques may be used in combination. The same technique may be repeated a plurality of times.

The metal elements can be added to the solution in the form of metal alkoxides, metal salt compounds, metal ions, or particles containing the metal elements.

For the metal component included in the repair solution, one selected from a group including lithium, sodium, potassium, magnesium, calcium, yttrium, titanium, zirconium, hafnium, vanadium, niobium, tantalum, and other rare-earth elements can be used.

One favorable example of the repair solution is a solution containing a zirconium component and a solvent, and optionally a stabilizer and/or a dispersant. Most of the zirconium component included in the solution is transformed into zirconium oxide (ZrO₂) by the heat treatment. The eutectic temperature of SiO₂ and ZrO₂ is 1683° C., that of Al₂O₃ and ZrO₂ is 1720° C., and that of mullite and ZrO₂ is 1700° C. These eutectic temperatures fall within the range of the heating temperature in step (iii), 1595° C. or higher and lower than 1730° C., and is lower than the melting point of silica (1730° C.), the melting point of alumina (2070° C.), and the melting point of mullite (1850° C.). Crack areas infiltrated with the repair solution can thus be selectively melted to reduce cracks at a temperature where the regions comprising silicon dioxide, the regions comprising aluminum oxide, and the regions comprising mullite can be prevented from melting.

Zirconium alkoxides, zirconium salt compounds, zirconium ion, and zirconium-containing particles can be used as the zirconium component. For the stabilizer, organic acids, surfactants, and chelating agents are suitable.

For a zirconium alkoxide-containing solution, a solution containing one selected from a group including zirconium tetraethoxide, zirconium tetra-n-propoxide, zirconium tetraisopropoxide, zirconium tetra-n-butoxide, and zirconium tetra-t-butoxide, and an organic solvent and a stabilizer is suitable.

For a zirconium salt compound-containing solution, a solution containing an alkoxide chloride or alkoxide nitrate, an organic solvent, and a stabilizer is suitable.

For a zirconium ion-containing solution, a solution containing zirconium ion and water can be used, optionally with a stabilizer. The amount of water in the solution is desirably more than or equal to 10 mass % of the solution excluding metal ions. The solution may contain an organic solvent aside from water. The zirconium ion can be generated by dissolving a zirconium ion-containing material such as zirconium salts and zirconium alkoxides in the solvent.

For a solution containing zirconium-containing particles, one containing zirconium particles or zirconium oxide particles, a solvent, and a dispersant is desirable. For the sake of crack infiltration, the particle size is desirably 300 nm or less, preferably 50 nm or less. The dispersant desirably contains at least one of an organic acid, a silane coupling agent, and a surfactant. Favorable solvents include alcohols, ketones, esters, ethers, ester-modified ethers, hydrocarbons, halogenated hydrocarbons, amides, water, oils, and mixtures of two or more of these.

If the repair solution containing the zirconium component is impregnated before step (iii), a region comprising zirconium oxide is formed in the shaped object after step (iii). The formation of the region comprising zirconium oxide in addition to the foregoing three or four regions increases the number of regions formed in the ceramic structure, whereby the mechanical strength of the ceramic structure can be improved.

### <Ceramic Structure>

The ceramic structure according to the present invention obtained by the foregoing method has a low porosity and includes three regions that are a region comprising oxide which contains Si and Al, a region comprising mullite, and a region comprising aluminum oxide. The oxide-equivalent mole ratio SiO₂/Al₂O₃ in the ceramic structure satisfies 0.1/0.9 to 0.7/0.3. The element number ratio Si/Al in the region comprising oxide which contains Si and Al is 6 to 12. As described above, a region comprising silicon dioxide is also included depending on the heat treatment time.

Such a ceramic structure can be obtained by direct shaping using the material powder satisfying the oxide-equivalent mole ratio SiO₂/Al₂O₃ of 0.1/0.9. to 0.7/0.3, followed by the heat treatment in the foregoing temperature range.

If the ceramic structure includes regions comprising silicon dioxide, cristobalite is desirably included. Cristobalite has a high density and excellent mechanical strength compared to amorphous silica.

If cracks are impregnated with the repair solution before the heat treatment, the number of regions increase from three to four, or from four to five. If a zirconium-containing solution is used as the repair solution, the ceramic structure includes four or five regions with the additional region comprising zirconium oxide. The mechanical strength of such a ceramic structure can be high because of the effect of suppressing crack development due to the presence of a plurality of different regions, compared to the case where the cracks are repaired without using the repair solution.

The ceramic structure according to the present invention desirably has a porosity of 10% or less. At the porosity of 10% or less, the ceramic structure can provide a mechanical strength sufficient for use as a structural part. As will be described in detail below, the porosity refers to an open porosity.

### [Methods for Evaluating Property Values]

### <Mechanical Strength>

The mechanical strength of the structure is evaluated by a three-point bending test based on the Japanese Industrial Standards (JIS) R1601 for room temperature flexural strength test of fine ceramics. Specifically, the mechanical strength can be calculated from the maximum bending stress when the specimen is broken, where the specimen is placed on two supports spaced L [mm] apart and a load of P [N] is applied to a point at the center between the supports. The three-point bending strength is determined by averaging the calculations of ten specimens each using:

3×P×L/(2×w×t²), (Eq. 1)

where P [N] is the maximum load at fracture, L [mm] is the distance between the outer supports, w [mm] is the width of the specimen, and t [mm] is the thickness of the specimen.

### <Porosity>

The porosity of the shaped object was evaluated by the method based on JIS R1634 for the measurement method of density and open porosity of sintered fine ceramics. Specifically, the porosity can be determined by averaging the calculations of three ceramic structures similar to the specimens used in measuring the mechanical strength, using {(W3−W1)/(W3−W2)}×100, where W1 is the dry mass of the shaped object, W2 is the mass in water, and W3 is the saturated mass.

### <Proportions of Regions Containing Crystal Structures and Mullite>

The crystal structures of the regions constituting the ceramic shaped object is identified by X-ray diffraction measurement, with the measurement surface prepared by polishing a section of the middle of the shaped object to be measured. Electron backscatter diffraction (EBSD) can be used to identify locations and crystal structures. If smaller regions (phases) are included, a transmission electron microscope (TEM) can be used to analyze compositions and crystal structures in a similar manner.

The content of each region in the shaped object can be calculated by extracting areas of approximately 230×145 μm from Al and Si elemental mapping images obtained by SEM-EDS analysis. The area size is not limited thereto. Variations can be suppressed by calculating the content in an area of 200 μm×100 μm or more in total. The proportion of regions 301 comprising aluminum oxide can be calculated as a ratio to the entire area by binarizing the Si elemental mapping image (Si mapping image) so that only black regions remain.

The proportion of regions 302 comprising mullite can be determined by the following procedure. First, the Al elemental mapping image (Al mapping image) is binarized with a threshold set to a brightness higher than that of the regions 302 comprising mullite, and the total value of regions 301 comprising aluminum oxide and the regions 302 comprising mullite is calculated. The proportion of the regions 302 comprising mullite can be calculated by subtracting the proportion of the regions 301 comprising aluminum oxide in the foregoing Si mapping image from the value.

The proportion of regions 401 comprising silicon dioxide can be calculated as a ratio to the entire area by binarizing the Al mapping image so that only black regions can be extracted.

To calculate the proportion of regions 303 comprising oxide which contains Si and Al, the Si mapping image is initially binarized with a threshold set to a brightness higher than that of the regions 303 comprising oxide which contains Si and Al. The total value of the regions 401 comprising silicon dioxide and the regions 303 comprising oxide which contains Si and Al is then calculated. The proportion can be calculated by subtracting the proportion of the regions 401 comprising silicon dioxide in the foregoing Al mapping image from the total value.

To maintain high mechanical strength, the regions 302 comprising mullite with relatively high mechanical strength are desirably large, not the regions comprising silicon dioxide or the regions comprising oxide which contains Si and Al. Whether the regions comprising mullite are large or small can be determined based on what vol % of the maximum amount of mullite formation the mullite actually formed in the ceramic structure occupies, by referring to the values of the maximum amount of mullite formation listed in Table 1. Specifically, the area ratio of regions 302 comprising mullite is calculated by the foregoing method in each of a plurality of sections of the ceramic structure. Next, the obtained values are converted into ratios with respect to the maximum amount of mullite formation calculated for the same mole ratio SiO₂/Al₂O₃ as that of the ceramic structure, illustrated in Table 1. Whether the regions comprising mullite are large or small is determined based on the average of the ratios. Here, the area percentages calculated in the plurality of sections are averaged into a value corresponding to volume percentage.

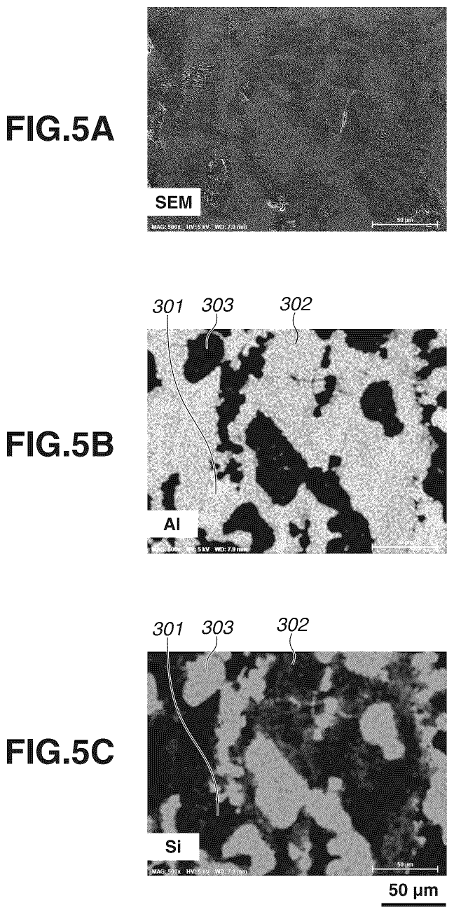

If the proportion of the regions 302 comprising mullite to the maximum amount of mullite formation is 75 vol % or more, a three-point bending strength of 80 [MPa] or more can be obtained to construct a member easy to handle. For example, the proportion of the regions 302 comprising mullite to the maximum amount of mullite formation in the ceramic structure according to the present invention illustrated in FIGS. 4A to 4C (twentieth example) is calculated to be 76.0 vol %. The proportion of the regions 302 comprising mullite to the maximum amount of mullite formation in a ceramic structure according to the present invention illustrated in FIGS. 5A to 5C (nineteenth example) is calculated to be 95.0 vol %.

### <Composition Analysis>

The contents of Si, Al, Zr, Tb, and Pr in the powder, the shaped object, or the ceramic structure are measured by inductively coupled plasma atomic emission spectroscopy (ICP-AES), glow discharge mass spectrometry (GDMS), or inductively coupled plasma mass spectrometry (ICP-MS).

### EXAMPLES

### First Example

Amorphous SiO₂ powder with an average particle diameter of approximately 28 μm, Al₂O₃ powder with an average particle diameter of approximately 20 μm, and SiO powder with an average particle diameter of 4 μm were prepared. The powders were weighed so that SiO₂ powder was 44.4 mass %, Al₂O₃ powder was 53.5 mass %, and SiO powder was 2.1 mass % (see Table 2). The components of the material powder included 60 mol % of SiO₂ equivalent and 40 mol % of Al₂O₃. The weighed powders were mixed in a dry ball mill for 30 minutes to obtain a mixed powder.

Next, shaped objects were fabricated by the same processes as illustrated in FIGS. 1A to 1H. The fabricated shaped objects had a rectangular solid shape of 5 mm×42 mm×6 mm. A 3D SYSTEMS ProX DMP 100 (trade name) equipped with a fiber laser (beam diameter 65 μm, oscillation wavelength 1070 mm) with a maximum power of 50 W was used to form the shaped objects.

Initially, a 20-μm-thick first powder layer of the material powder was formed on the alumina base 130 using a roller (FIGS. 1A and 1B).

Next, the powder layer was irradiated with a 47.5-W scanned laser beam to melt and solidify the material powder in a 5 mm×42 mm rectangular area, whereby a solidified portion 100 was formed (FIG. 1C). The drawing speed here was 60 mm/s and the drawing pitch was 80 μm. The laser beam was scanned so that the drawing lines intersected the sides of the rectangle at 45°.

Next, a new 20-μm-thick powder layer was formed on the solidified portion 100 using the roller. The powder layer was irradiated with the scanned laser beam to melt and solidify the material powder in a 5 mm×42 mm rectangular area, whereby a solidified portion 100 was formed (FIGS. 1D and 1E). Here, the laser was scanned in a direction orthogonal to the drawing lines of the first layer. Such processes were repeated until the solidified portion reached a height of 6 mm, whereby 14 shaped objects of 42 mm×5 mm×6 mm were fabricated.

The fabricated shaped objects were separated from the alumina base, and heated in an electric furnace. Specifically, the shaped objects were heated to 1690° C. in 2.5 hours in the atmospheric environment and maintained at 1690° C. for 20 minutes. The energization was then ended and the shaped objects were cooled to or below 200° C. in 5.0 hours to obtain 14 ceramic structures.

Three of the obtained ceramic structures were used as samples for porosity measurement. The porosity evaluation showed a porosity of 6.8%.

The composition of the obtained ceramic structures was measured by ICP-AES. Si was found to be an SiO₂ equivalent of 43.9 mass %, and Al an Al₂O₃ equivalent of 56.1 mass %. The mole ratio SiO₂/Al₂O₃ was 0.57/0.43 (see Table 3).

Next, to analyze the regions constituting the ceramic structures and conduct a three-point bending strength test and porosity measurement, the remaining 11 ceramic structures were cut and polished into samples of 40 mm×4 mm×3 mm. Both long sides of one of the machined samples were cut off to leave the midsection of the ceramic structure using a wire saw, whereby a specimen of 10 mm×4 mm×3 mm was obtained. The specimen was coarsely ground so that the 3-mm sides were reduced to approximately 1.5 mm, and then mirror-polished to obtain a 10 mm×4 mm observation surface.

The observation surface was subjected to X-ray diffraction, SEM observation, SEM-EDS, and EBSD. SEM-EDS and EBSD were performed to analyze 10 different locations with a field of view size of 100 μm×100 μm, whereby the compositions and crystal structures were mapped. Comprehensive analysis of the results showed that the ceramic structure included four regions that were a region comprising silica (SiO₂), a region comprising oxide which contains Si and Al, a region comprising mullite, and a region comprising aluminum oxide. A region comprising oxide which contains Si and Al that is presumably a crack-repaired region was also observed. Table 3 marks the fields of regions observed to exist with “∘”, and the fields of regions not observed to exist with “x”. The analysis showed that silica in the region comprising silicon dioxide was cristobalite, and the region comprising mullite and the region comprising aluminum oxide were both crystalline.

The remaining 10 specimens for the strength test were subjected to the bending strength test. The three-point bending strength was calculated to be 103 [MPa].

Table 3 illustrates the evaluations of the contents (oxide-equivalent mass percentages) of Si, Al, Tb, Pr, and Zr, the oxide-equivalent mole ratio SiO₂/Al₂O₃, the porosity, and the three-point bending strength of the ceramic structure.

Table 2 illustrates the weighed values of the material powders SiO₂, Al₂O₃, SiO, Tb₄O₇, and Pr₆O₁₁. Table 3 illustrates the contents of Si, Al, Tb, Pr, and Zr in terms of numerical values equivalent to SiO₂, Al₂O₃, Tb₂O₃, Pr₂O₃, and ZrO₂, respectively.

TABLE 2

| | Base material | | | | | | | | |
|---|---|---|---|---|---|---|---|---|---|
| | SiO₂ | | | Al₂O₃ | | | | | Mole ratio |
| | | Average | | | Average | | | | SiO₂/Al₂O₃ |
| | | particle | | | particle | Absorber | | | (oxide- |
| | Content | diameter | | Content | diameter | SiO | Tb₄O₇ | Pr₆O₁₁ | equivalent |
| | [wt %] | [μm] | Crystallinity | [wt %] | [μm] | [wt %] | [wt %] | [wt %] | value) |
| First | 44.4 | 28 | amorphous | 53.5 | 20 | 2.1 | 0 | 0 | 0.60/0.40 |
| example | | | | | | | | | |
| Second | 55.5 | 28 | amorphous | 42.4 | 20 | 2.1 | 0 | 0 | 0.70/0.30 |
| example | | | | | | | | | |
| Third | 34.7 | 28 | amorphous | 63.4 | 20 | 1.9 | 0 | 0 | 0.50/0.50 |
| example | | | | | | | | | |
| Fourth | 30.2 | 28 | amorphous | 67.9 | 20 | 1.9 | 0 | 0 | 0.45/0.55 |
| example | | | | | | | | | |
| Fifth | 10.1 | 28 | amorphous | 87.8 | 20 | 2.1 | 0 | 0 | 0.20/0.80 |
| example | | | | | | | | | |
| Sixth | 6 | 28 | amorphous | 91.9 | 20 | 2.1 | 0 | 0 | 0.14/0.86 |
| example | | | | | | | | | |
| Seventh | 44.4 | 17 | amorphous | 53.5 | 20 | 2.1 | 0 | 0 | 0.60/0.40 |
| example | | | | | | | | | |
| Eighth | 44.4 | 10 | amorphous | 53.5 | 20 | 2.1 | 0 | 0 | 0.60/0.40 |
| example | | | | | | | | | |
| Nineth | 44.4 | 38 | cristobalite | 53.5 | 20 | 2.1 | 0 | 0 | 0.60/0.40 |
| example | | | | | | | | | |
| Tenth | 43.2 | 17 | amorphous | 49.6 | 20 | 0 | 7.2 | 0 | 0.60/0.40 |
| example | | | | | | | | | |
| Eleventh | 43.6 | 10 | amorphous | 50 | 20 | 0 | 0 | 6.4 | 0.60/0.40 |
| example | | | | | | | | | |
| Twelfth | 44.4 | 28 | amorphous | 53.5 | 20 | 2.1 | 0 | 0 | 0.60/0.40 |
| example | | | | | | | | | |
| Thirteenth | 55.5 | 17 | amorphous | 42.4 | 20 | 2.1 | 0 | 0 | 0.70/0.30 |
| example | | | | | | | | | |
| Fourteenth | 34.7 | 17 | amorphous | 63.4 | 20 | 1.9 | 0 | 0 | 0.50/0.50 |
| example | | | | | | | | | |
| Fifteenth | 30.2 | 17 | amorphous | 67.9 | 20 | 1.9 | 0 | 0 | 0.45/0.55 |
| example | | | | | | | | | |
| Sixteenth | 44.4 | 28 | amorphous | 53.5 | 20 | 2.1 | 0 | 0 | 0.60/0.40 |
| example | | | | | | | | | |
| Seventeenth | 44.4 | 17 | amorphous | 53.5 | 20 | 2.1 | 0 | 0 | 0.60/0.40 |
| example | | | | | | | | | |
| Eighteenth | 44.4 | 17 | amorphous | 53.5 | 20 | 2.1 | 0 | 0 | 0.60/0.40 |
| example | | | | | | | | | |
| Nineteenth | 44.4 | 17 | amorphous | 53.5 | 20 | 2.1 | 0 | 0 | 0.60/0.40 |
| example | | | | | | | | | |
| Twentieth | 25.8 | 17 | amorphous | 53.5 | 20 | 1.9 | 0 | 0 | 0.40/0.60 |
| example | | | | | | | | | |
| First | 80 | 28 | amorphous | 17.6 | 20 | 2.4 | 0 | 0 | 0.89/0.11 |
| comparative | | | | | | | | | |
| example | | | | | | | | | |
| Second | 62.6 | 28 | amorphous | 35.3 | 20 | 2.1 | 0 | 0 | 0.75/0.25 |
| comparative | | | | | | | | | |
| example | | | | | | | | | |
| Third | 2.7 | 28 | amorphous | 95.2 | 20 | 2.1 | 0 | 0 | 0.05/0.95 |
| comparative | | | | | | | | | |
| example | | | | | | | | | |
| Fourth | 0 | — | — | 98.5 | 20 | 1.5 | 0 | 0 | 0.03/0.97 |
| comparative | | | | | | | | | |
| example | | | | | | | | | |

TABLE 3

| | Fifth | Fourth | Third | Second | First | |
|---|---|---|---|---|---|---|
| | example | example | example | example | example | |
| Number of times of impregnation | 0 | 0 | 0 | 0 | 0 | |
| Content in ceramic structure | 11.4 | 30.5 | 34.1 | 53.9 | 43.9 | Si |
| (oxide-equivalent value) | 88.7 | 69.5 | 65.9 | 46.1 | 56.1 | A1 |
| [wt %] | 0 | 0 | 0 | 0 | 0 | Tb |
| | 0 | 0 | 0 | 0 | 0 | Pr |
| | 0 | 0 | 0 | 0 | 0 | Zr |
| Mole ratio SiO₂/Al₂O₃ | 0.18/0.82 | 0.43/0.57 | 0.47/0.53 | 0.66/0.34 | 0.57/0.43 | |
| (oxide-equivalent value) | | | | | | |
| Presence or absence of region | ∘ | ∘ | ∘ | ∘ | ∘ | Silicon dioxide |
| | ∘ | ∘ | ∘ | ∘ | ∘ | Aluminum oxide |
| | ∘ | ∘ | ∘ | ∘ | ∘ | Oxide containing Si and Al |
| | ∘ | ∘ | ∘ | ∘ | ∘ | Mullite |
| | x | x | x | x | x | Zirconium oxide |
| Sintering temperature [° C.] | 1690 | 1690 | 1690 | 1690 | 1690 | |
| Sintering time [min] | 20 | 20 | 20 | 20 | 20 | |
| Porosity [vol %] | 6.6 | 6.5 | 7 | 9 | 6.8 | |
| Three-point bending strength | 108 | 92 | 100 | 95 | 103 | |

| | Eleventh | Tenth | Nineth | Eighth | Seventh | Sixth |
|---|---|---|---|---|---|---|
| | example | example | example | example | example | example |
| Number of times of impregnation | 0 | 0 | 0 | 0 | 0 | 0 |
| Content in ceramic structure | 42 | 40.8 | 44.4 | 41.9 | 42.9 | 7.3 |
| (oxide-equivalent value) | 51.9 | 52.2 | 55.6 | 58.1 | 57.1 | 92.7 |
| [wt %] | 0 | 7 | 0 | 0 | 0 | 0 |
| | 6.1 | 0 | 0 | 0 | 0 | 0 |
| | 0 | 0 | 0 | 0 | 0 | 0 |
| Mole ratio SiO₂/Al₂O₃ | 0.58/0.42 | 0.57/0.43 | 0.58/0.42 | 0.55/0.45 | 0.56/0.44 | 0.12/0.88 |
| (oxide-equivalent value) | | | | | | |
| Presence or absence of region | ∘ | ∘ | ∘ | ∘ | ∘ | ∘ |
| | ∘ | ∘ | ∘ | ∘ | ∘ | ∘ |
| | ∘ | ∘ | ∘ | ∘ | ∘ | ∘ |
| | ∘ | ∘ | ∘ | ∘ | ∘ | ∘ |
| | x | x | x | x | x | x |
| Sintering temperature [° C.] | 1680 | 1680 | 1680 | 1690 | 1690 | 1690 |
| Sintering time [min] | 20 | 20 | 20 | 20 | 20 | 20 |
| Porosity [vol %] | 6.3 | 6.4 | 6.5 | 3.1 | 5 | 6.6 |
| Three-point bending strength | 89 | 91 | 85 | 113 | 108 | 106 |
| | Seventeenth | Sixteenth | Fifteenth | Fourteenth | Thirteenth | Twelfth |
| | example | example | example | example | example | example |
| Number of times of impregnation | 0 | 1 | 1 | 1 | 1 | 1 |
| Content in ceramic structure | 42.9 | 44.9 | 30.2 | 33.5 | 53.5 | 43.8 |
| (oxide-equivalent value) | 57.1 | 55.1 | 69.8 | 66.2 | 46.2 | 55.8 |
| [wt %] | 0 | 0 | 0 | 0 | 0 | 0 |
| | 0 | 0 | 0 | 0 | 0 | 0 |
| | 0 | 0 | 0.34 | 0.28 | 0.31 | 0.33 |
| Mole ratio SiO₂/Al₂O₃ | 0.56/0.44 | 0.58/0.42 | 0.42/0.58 | 0.46/0.54 | 0.66/0.34 | 0.57/0.43 |
| (oxide-equivalent value) | | | | | | |
| Presence or absence of region | x | ∘ | ∘ | ∘ | ∘ | ∘ |
| | ∘ | ∘ | ∘ | ∘ | ∘ | ∘ |
| | ∘ | ∘ | ∘ | ∘ | ∘ | ∘ |
| | ∘ | ∘ | ∘ | ∘ | ∘ | ∘ |
| | x | ∘ | ∘ | ∘ | ∘ | ∘ |
| Sintering temperature [° C.] | 1690 | 1650 | 1690 | 1690 | 1690 | 1690 |
| Sintering time [min] | 40 | 20 | 20 | 20 | 20 | 20 |
| Porosity [vol %] | 4 | 9.3 | 6.1 | 6 | 5.4 | 5.6 |
| Three-point bending strength | 111 | 83 | 97 | 104 | 99 | 109 |

| | Third | Second | First | | | |
|---|---|---|---|---|---|---|
| | comparative | comparative | comparative | Twentieth | Nineteenth | Eighteenth |
| | example | example | example | example | example | example |
| Number of times of impregnation | 0 | 0 | 0 | 0 | 0 | 0 |
| Content in ceramic structure | 3.5 | 62 | 80.1 | 25.7 | 42.9 | 42.9 |
| (oxide-equivalent value) | 96.5 | 38 | 19.9 | 74.2 | 57.1 | 57.1 |
| [wt %] | 0 | 0 | 0 | 0 | 0 | 0 |
| | 0 | 0 | 0 | 0 | 0 | 0 |
| | 0 | 0 | 0 | 0 | 0 | 0 |
| Mole ratio SiO₂/Al₂O₃ | 0.06/0.94 | 0.73/0.27 | 0.87/0.13 | 0.56/0.44 | 0.37/0.63 | 0.56/0.44 |
| (oxide-equivalent value) | | | | | | |
| Presence or absence of region | ∘ | ∘ | ∘ | ∘ | x | x |
| | ∘ | ∘ | ∘ | ∘ | ∘ | ∘ |
| | ∘ | ∘ | ∘ | ∘ | ∘ | ∘ |
| | ∘ | ∘ | ∘ | ∘ | ∘ | ∘ |
| | x | x | x | x | x | x |
| Sintering temperature [C] | 1690 | 1690 | 1690 | 1690 | 1690 | 1690 |
| Sintering time [min] | 20 | 20 | 20 | 20 | 120 | 80 |
| Porosity [vol %] | 25.3 | 13.4 | 16.3 | 6.2 | 3.5 | 3.9 |
| Three-point bending strength | 41 | 28 | 25 | 93 | 107 | 103 |

| | Fourth |
|---|---|
| | comparative |
| | example |
| Number of times of impregnation | 0 |
| Content in ceramic structure | 1.1 |
| (oxide-equivalent value) | 98.9 |
| [wt %] | 0 |
| | 0 |
| | 0 |
| Mole ratio SiO₂/Al₂O₃ | 0.02/0.98 |
| (oxide-equivalent value) | |
| Presence or absence of region | ∘ |
| | ∘ |
| | ∘ |
| | ∘ |
| | x |
| Sintering temperature [° C.] | 1690 |
| Sintering time [min] | 20 |
| Porosity [vol %] | 28.7 |
| Three-point bending strength | 19 |

### Second to Sixth Examples

Ceramic structures were fabricated in a manner similar to that of the first example except that the mass ratios of the SiO₂ powder, Al₂O₃ powder, and SiO powder included in the material powder were changed. Table 2 lists the mass ratios of the material powders in the respective examples. Table 3 lists the porosity, the mass ratios of SiO₂ and Al₂O₃, the mole ratio SiO₂/Al₂O₃, and the three-point bending strength of the obtained ceramic structures along with the sintering temperature. Table 3 also lists the presence or absence of the four regions, or the region comprising silicon dioxide, the region comprising oxide which contains Si and Al, the region comprising mullite, and the region comprising aluminum oxide. The crystal structure analysis showed that all the ceramic structures contained cristobalite in the region comprising silicon dioxide, and crystals in the region comprising mullite and the region comprising aluminum oxide. In all the ceramic structures, the region comprising oxide which contains Si and Al that is presumably a crack-repaired portion was observed.

### Seventh Example

A ceramic structure was fabricated in a manner similar to that of the first example except that the average particle diameter of the SiO₂ powder was changed to 17 μm. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The crystal structure analysis showed that the region comprising silicon dioxide contained cristobalite, and the region comprising mullite and the region comprising aluminum oxide contained crystals as well. A region comprising oxide which contains Si and Al that is presumably a crack-repaired portion was also observed. The porosity was 5.0%, which is lower than in the first to sixth examples. The ratio of the actual region comprising mullite to the maximum amount of mullite formation was as high as 78.9 vol % and showed a correlation with the three-point bending strength of 108 [MPa].

### Eighth Example

A ceramic structure was fabricated in a manner similar to that of the first example except that the average particle diameter of the SiO₂ powder was changed to 10 μm. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The crystal structure analysis showed that the region comprising silicon dioxide contained cristobalite, and the region comprising mullite and the region comprising aluminum oxide contained crystals as well. A region comprising oxide which contains Si and Al that is presumably a crack-repaired portion was also observed.

The porosity was 3.1%, which is lower than in the other examples. The three-point bending strength was as high as 113 [MPa]. Again, the ratio of the actual region comprising mullite to the maximum amount of mullite formation was 91.8 vol % and showed a correlation with the high strength.

### Ninth Example

A ceramic structure was fabricated in a manner similar to that of the first example except that the average particle diameter of the SiO₂ powder was changed to that of cristobalite, 38 μm, and the sintering temperature of step (iii) was changed to 1680° C. The obtained ceramic structure was evaluated in a manner similar to that of the other examples, and Table 3 illustrates the evaluations. The crystal structure analysis showed that the region comprising silicon dioxide contained cristobalite, and the region comprising mullite and the region comprising aluminum oxide contained crystals as well. A region comprising oxide which contains Si and Al that is presumably a crack-repaired portion was also observed.

### Tenth Example

A ceramic structure was fabricated in a manner similar to that of the seventh example except that the absorber was changed to Tb₄O₇ powder with an average particle diameter of 4 μm and the SiO₂ powder, the Al₂O₃ powder, and the Tb₄O₇ powder were mixed at the mass ratios illustrated in Table 2, and the sintering temperature of step (iii) was changed to 1680° C. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The crystal structure analysis showed that the region comprising silicon dioxide contained cristobalite, and the region comprising mullite and the region comprising aluminum oxide contained crystals as well. A region comprising oxide which contains Si and Al that is presumably a crack-repaired portion was also observed.

### Eleventh Example

A ceramic structure was fabricated in a manner similar to that of the eighth example except that the absorber was changed to Pr₆O₁₁ powder with an average particle diameter of 4 μm. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The crystal structure analysis showed that the region comprising silicon dioxide contained cristobalite, and the region comprising mullite and the region comprising aluminum oxide contained crystals as well. A region comprising oxide which contains Si and Al that is presumably a crack-repaired portion was also observed.

### Twelfth Example

A ceramic structure was fabricated in a manner similar to that of the first example except that cracks in the shaped object were impregnated with a zirconium component-containing solution before step (iii). The zirconium component-containing solution was prepared in the following manner. A solution was prepared by dissolving 85 mass % of zirconium butoxide (zirconium (IV) butoxide [hereinafter, referred to as Zr(O-n-Bu)4]) in 1-butanol. The Zr(O-n-Bu)4 solution was dissolved in 2-propanol (isopropyl alcohol [IPA]), and ethyl acetoacetate (EAcAc) was added as a stabilizer. The mole ratios of the components were Zr(O-n-Bu)4:IPA:EAcAc=1:15:2. The solution was then stirred at room temperature for approximately three hours, whereby the zirconium component-containing solution was prepared.

Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The crystal structure analysis showed that the region comprising silicon dioxide contained cristobalite, and the region comprising mullite and the region comprising aluminum oxide contained crystals as well. A region comprising oxide which contains Si and Al that is presumably a crack-repaired portion was also observed. Moreover, regions comprising zirconium oxide were observed to be dispersed with the crack-repaired portion and the connected region comprising oxide which contains Si and Al.

A high three-point bending strength was obtained compared to the first example where the fabrication conditions were the same except that the shaped object is not impregnated with the repair solution. This is presumably due to the increased complexity of the regions constituting the ceramic structure, resulting from the increase in the regions comprising zirconium oxide.

### Thirteenth Example

A ceramic structure was fabricated in a manner similar to that of the seventh example except that the mass ratios of the SiO₂ powder, the Al₂O₃ powder, and the SiO powder included in the material powder were changed to the values illustrated in Table 2. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The crystal structure analysis showed that the region comprising silicon dioxide contained cristobalite, and the region comprising mullite and the region comprising aluminum oxide contained crystals as well.

The ceramic structure was observed to include five regions that were a region comprising silicon dioxide, a region comprising oxide which contains Si and Al, a region comprising mullite, a region comprising aluminum oxide, and a region comprising zirconium oxide. A region comprising oxide which contains Si and Al that is presumably a crack-repaired portion was also observed. A high three-point bending strength was obtained compared to the second example where the fabrication conditions were the same except that the shaped object was not impregnated with the repair solution.

### Fourteenth Example

A ceramic structure was fabricated in a manner similar to that of the seventh example except that the mass ratios of the SiO₂ powder, the Al₂O₃ powder, and the SiO powder included in the material powder were changed to the values illustrated in Table 2. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The region comprising silicon dioxide contain cristobalite, and the region comprising mullite and the region comprising aluminum oxide contained crystals as well.

The ceramic structure was observed to include five regions that were a region comprising silicon dioxide, a region comprising oxide which contains Si and Al, a region comprising mullite, a region comprising aluminum oxide, and a region comprising zirconium oxide. A region comprising oxide which contains Si and Al that is presumably a crack-repaired portion was also observed. A high three-point bending strength was obtained compared to the third example where the fabrication conditions were the same except that the shaped object was not impregnated with the repair solution.

### Fifteenth Example

A ceramic structure was fabricated in a manner similar to that of the seventh example except that the mass ratios of the SiO₂ powder, the Al₂O₃ powder, and the SiO powder included in the material powder were changed to the values illustrated in Table 2. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The crystal structure analysis showed that the region comprising silicon dioxide contained cristobalite, and the region comprising mullite and the region comprising aluminum oxide contained crystals as well.

The ceramic structure was observed to include five regions that were a region comprising silicon dioxide, a region comprising oxide which contains Si and Al, a region comprising mullite, a region comprising aluminum oxide, and a region comprising zirconium oxide. A region comprising oxide which contains Si and Al that is presumably a crack-repaired portion was also observed. A high three-point bending strength was obtained compared to the fourth example where the fabrication conditions were the same except that the shaped object was not impregnated with the repair solution and silica has a different particle diameter.

### Sixteenth Example

A ceramic structure was fabricated in a manner similar to that of the first example except that the sintering temperature of step (iii) was changed to 1650° C. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The crystal structure analysis showed that the region comprising silicon dioxide contained cristobalite, and the region comprising mullite and the region comprising aluminum oxide contained crystals as well. A region comprising oxide which contains Si and Al that is presumably a crack-repaired portion was also observed.

### Seventeenth to Nineteenth Examples

In the seventeenth, eighteenth, and nineteenth examples, ceramic structures were fabricated in a manner similar to that of the seventh example except that the sintering temperature maintaining time of step (iii) was set to 40 minutes, 80 minutes, and 120 minutes, respectively. Table 3 illustrates the mass ratios of SiO₂ and Al₂O₃, the mole ratio SiO₂/Al₂O₃, the presence or absence of the four regions, the porosity, and the three-point bending strength of the obtained ceramic structures along with the sintering temperature.

In the ceramic structures according to the seventeenth to nineteenth examples, no region comprising silicon dioxide was detected, and three regions that were a region comprising oxide which contains Si and Al, a region comprising mullite, and a region comprising aluminum oxide were observed.

The crystal structure analysis showed that the region comprising mullite and the region comprising aluminum oxide both included crystals. A region comprising oxide which contains Si and Al that is presumably a crack-repaired portion was also observed.

Specifically, the proportion of the region comprising mullite to the producible amount of mullite in the seventeenth example was as high as 83.3 vol % and showed a correlation with the three-point bending strength of 111 [MPa]. FIGS. 5A to 5C are a SEM image, an EDS Al elemental mapping image, and an EDS Si elemental mapping image of the ceramic structure obtained in the nineteenth example, respectively. The proportion of the region comprising mullite to the producible amount of mullite in the nineteenth example, calculated using FIGS. 5B and 5C, was as high as 95.0 vol % and the three-point bending strength was as high as 107 [MPa].

In the seventh, seventeenth, and nineteenth examples, the proportion of the region comprising mullite was higher than or equal to 75 vol % and tended to increase as the sintering time increased. Moreover, the three-point bending strength was maintained at high level. In the seventeenth and nineteenth examples, it is confirmed that the increased heat treatment time reduces the porosity as compared to the seventh example.

The region comprising mullite with relatively high mechanical strength was thus confirmed to occupy a wider area than that of the region comprising silicon dioxide and the region comprising oxide which contains Si and Al with relatively low mechanical strength. Such a state is particularly desirable in maintaining high mechanical strength.

### Twentieth Example

In the twentieth example, a ceramic structure was fabricated in a manner similar to that of the seventh example except that the mass ratios of the SiO₂ powder, the Al₂O₃ powder, and the SiO powder included in the material powder were changed. Table 2 illustrates the mass ratios of the material powder in the respective examples. Table 3 illustrates the porosity, the mass ratios of SiO₂ and Al₂O₃, the mole ratio SiO₂/Al₂O₃, and the three-point bending strength of the obtained ceramic structure along with the sintering temperature. Table 3 further illustrates the presence or absence of four regions that are a region comprising silicon dioxide, a region comprising oxide which contains Si and Al, a region comprising mullite, and a region comprising aluminum oxide. FIG. 4A illustrates a SEM image of the obtained ceramic structure. FIGS. 4B and 4C illustrate an EDS Al elemental mapping image and an EDS Si elemental mapping image, respectively.

The crystal structure analysis and the SEM-EDS analysis showed that in the ceramic structure, the region 401 comprising silicon dioxide contained cristobalite, and the region 302 comprising mullite and the region 301 comprising aluminum oxide contained crystals as well. There was also a region 303 comprising oxide which contains Si and Al that is presumably a crack-repaired portion CR.

The proportion of the region comprising mullite to the producible amount of mullite was as high as 76.0 vol % and showed a correlation with the three-point bending strength of 93 [MPa].

### First Comparative Example

A ceramic structure was fabricated in a manner similar to that of the first example except that the mass ratios of the SiO₂ powder, the Al₂O₃ powder, and the SiO powder included in the material powder were changed to the values illustrated in Table 2. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The crystal structure analysis showed that the region comprising silicon dioxide contained cristobalite, and the region comprising mullite and the region comprising aluminum oxide contained crystals as well. A region comprising oxide which contains Si and Al that is presumably a crack-repaired portion was also observed.

There were observed four regions, or a region comprising silicon dioxide, a region comprising oxide which contains Si and Al, a region comprising mullite, and a region comprising aluminum oxide, in the ceramic structure. However, the three-point bending strength was as low as 25 [MPa], which is not a suitable value for application as a structural part.

The porosity of 16.3% is higher than in the examples. The low three-point bending strength is thus considered to be due to the high porosity, or low compactness, of the ceramic structure. The high porosity is considered to be ascribable to the low content of aluminum oxide in the material powder. During the laser beam irradiation of step (ii), the molten aluminum oxide was presumably unable to spread throughout the shaped object, resulting in insufficient melting of silica.

### Second Comparative Example

A ceramic structure was fabricated in a manner similar to that of the first example except that the mass ratios of the SiO₂ powder, the Al₂O₃ powder, and the SiO powder included in the material powder were changed to the values illustrated in Table 2. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The region comprising silicon dioxide contained cristobalite, and the region comprising mullite and the region comprising aluminum oxide contained crystals as well. A region comprising oxide which contains Si and Al that is presumably a crack-repaired portion was also observed.

There were observed four regions, or a region comprising silicon dioxide, a region comprising oxide which contains Si and Al, a region comprising mullite, and a region comprising aluminum oxide, in the ceramic structure. However, the three-point bending strength was as low as 28 [MPa], which is not a suitable value for application as a structural part.

In the second comparative example, the porosity was as high as 13.4%. Like the first comparative example, this is presumably due to insufficient melting of silica, resulting from the low content of aluminum oxide in the material power with a mole ratio SiO₂/Al₂O₃ of 0.75/0.25.

### Third Comparative Example

A ceramic structure was fabricated in a manner similar to that of the first example except that the mass ratios of the SiO₂ powder, the Al₂O₃ powder, and the SiO powder included in the material powder were changed to the values illustrated in Table 2. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the sintering temperature. The crystal structure analysis showed that the region comprising silicon dioxide contained cristobalite, and the region comprising mullite and the region comprising aluminum oxide contained crystals as well. A region comprising oxide which contains Si and Al that is presumably a crack-repaired portion was also observed. However, the number of such regions was extremely small compared to the first to sixteenth examples.

The three-point bending strength of the third comparative example was as low as 41 [MPa], which is not a suitable value for application as a structural part. The high porosity is considered to be due to the low content of silicon dioxide in the material powder, which prevented the composition of the region comprising oxide which contains Si and Al melted during the heat treatment of step (iii) from spreading throughout cracks and hindered sufficient repair of the cracks.

### Fourth Comparative Example

A ceramic structure was fabricated in a manner similar to that of the first example except that the mass ratios of the SiO₂ powder, the Al₂O₃ powder, and the SiO powder included in the material powder were changed to the values illustrated in Table 2. Table 3 illustrates the mass ratios of SiO₂ and Al₂O₃, the mole ratio SiO₂/Al₂O₃, the presence or absence of the four regions, the porosity, and the three-point bending strength of the obtained ceramic structure along with the heating temperature. No region comprising oxide which contains Si and Al that is presumably a crack-repaired portion was observed.

The three-point bending strength of the fourth comparative example was as low as 41 [MPa], which is not a suitable value for application as a structural part. The reason for the high porosity is considered to be that the phenomenon of repairing the cracks in the shaped object did not occur sufficiently during the heat treatment of step (iii) because the material powder with the mole ratio SiO₂/Al₂O₃ of 0.03/0.97 contained little silicon dioxide.

The present invention is not limited to the foregoing exemplary embodiments, and various changes and modifications can be made without departing from the spirit and scope of the present invention. The following claims are therefore appended to set forth the scope of the present invention.

This application claims the benefit of priority based on Japanese Patent Application No. 2021-184895, filed on Nov. 12, 2021, and Japanese Patent Application No. 2022-179505, filed on Nov. 9, 2022, the entire contents of which are incorporated herein by reference.

According to the present invention, a ceramic structure having high mechanical strength can be manufactured at low cost using direct shaping.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A ceramic structure comprising
a portion including:
a first region comprising oxide which contains Si and Al;
a second region comprising oxide which contains Si and Al; and
a third region comprising oxide which contains Al,
wherein the second region is richer in Si than the first region,
wherein the third region is poorer in Si than the first region,
wherein an oxide-equivalent mole ratio SiO₂/Al₂O₃ of the portion satisfies 0.1/0.9 to 0.7/0.3, and
wherein at least one of the first and third regions is crystalline.

2. The ceramic structure according to claim 1, wherein a section of the ceramic structure includes a region comprising oxide which contains Si and Al with an average width of 1 μm or more and a length a ratio of which to the average width is 10 or more.

3. The ceramic structure according to claim 1, wherein a proportion of the first region in the portion satisfies 75 vol % or more of a maximum amount of mullite calculated from the oxide-equivalent mole ratio SiO₂/Al₂O₃ of the portion.

4. The ceramic structure according to claim 1, wherein the second region has an oxide-equivalent mole ratio SiO₂/Al₂O₃ of 12 to 24.

5. The ceramic structure according to claim 1, wherein the first region is crystalline.

6. The ceramic structure according to claim 1, wherein the third region is crystalline.

7. The ceramic structure according to claim 1, wherein the portion includes a fourth region comprising oxide which contains Si, and the fourth region is poorer in Al than the second region.

8. The ceramic structure according to claim 1, wherein the portion includes a fifth region comprising oxide which contains Zr.

9. The ceramic structure according to claim 1, wherein the first region comprises a silica-alumina compound.

10. The ceramic structure according to claim 1, wherein the first region comprises mullite.

11. The ceramic structure according to claim 1, wherein the second region is surrounded by the first and third regions.

12. The ceramic structure according to claim 7, wherein the fourth region is crystalline.

13. The ceramic structure according to claim 7, wherein the fourth region contains cristobalite.

14. A method for manufacturing a ceramic structure, comprising the steps of:
(i) disposing powder containing silicon dioxide particles, aluminum oxide particles, and an absorber exhibiting higher light absorbability for a wavelength of light included in an irradiating laser beam than that of silica and alumina, an oxide-equivalent mole ratio SiO₂/Al₂O₃ of the powder satisfying 0.1/0.9 to 0.7/0.3;
(ii) irradiating the powder with the laser beam to melt the powder, followed by solidification; and
(iii) subjecting a shaped object obtained by performing steps (i) and (ii) a plurality of times to heat treatment so that a maximum temperature reached is 1595° C. or higher and lower than 1730° C.,
wherein the shaped object after the heat treatment includes a crystalline region comprising at least oxide which contains Al.

15. The method for manufacturing a ceramic structure according to claim 14, wherein in step (iii), the heat treatment is performed so that the maximum temperature reached is 1600° C. or higher and lower than 1720° C.

16. The method for manufacturing a ceramic structure according to claim 14, wherein in step (iii), the heat treatment is performed so that the maximum temperature reached is maintained for one minute or more and four hours or less.

17. The method for manufacturing a ceramic structure according to claim 14, wherein the absorber has an absorbability of 10% or higher for the wavelength of light included in the laser beam.

18. The method for manufacturing a ceramic structure according to claim 17, wherein the absorber has an absorbability of 40% or higher for the wavelength of light included in the laser beam.

19. The method for manufacturing a ceramic structure according to claim 14, wherein the absorber is SiO.

20. The method for manufacturing a ceramic structure according to claim 14, wherein the silicon dioxide particles have an average particle diameter of 5 μm or more and 200 μm or less, and the absorber has an average particle diameter of 1 μm or more and less than 10 μm.

21. The method for manufacturing a ceramic structure according to claim 14, wherein an amount of the absorber added is 0.5 vol % or more and 10 vol % or less of the powder.

22. The method for manufacturing a ceramic structure according to claim 14, further comprising the step of impregnating the shaped object with a solution containing a metal element before step (iii).

23. The method for manufacturing a ceramic structure according to claim 22, wherein the metal element is Zr.

24. The method for manufacturing a ceramic structure according to claim 22, wherein the maximum temperature the shaped object reaches in the heat treatment of step (iii) is higher than a eutectic temperature of an oxide of the metal element and silicon dioxide.

25. The method for manufacturing a ceramic structure according to claim 22, wherein a content of the metal element in the powder is lower than 3.0 mass %.
